(19) United States
(12) Patent Application Publication
(10) Pub. No.: US 2016/0047730 A1
(43) Pub. Date: Feb. 18, 2016

(54) PARTICULATE-MEASURING METHOD, PARTICULATE-MEASURING SYSTEM, AND SYSTEM FOR MANUFACTURING ULTRAPURE WATER

(71) Applicant: KURITA WATER INDUSTRIES LTD., Tokyo (JP)

(72) Inventor: Yoichi TANAKA, Tokyo, (JP)

(73) Assignee: KURITA WATER INDUSTRIES LTD., Tokyo (JP)

(21) Appl. No.: 14/778,872

(22) PCT Filed: Mar. 13, 2014
(86) PCT No.: PCT/JP2014/056747

§ 371 Date: Sep. 21, 2015

(30) Foreign Application Priority Data
Mar. 28, 2013 (JP) 2013-070183

(51) Int. Cl. G01N 15/06

(52) U.S. Cl. CPC G01N 15/06

(57) ABSTRACT

An object of the invention is to provide a technology that can timely collects particulates in sample water even when abnormality is observed in the result obtained by a measurement unit for measuring particulates in sample water. Provided is a particulate-measuring method comprising filtering sample water continuously, even when a measurement unit for measuring particulates in sample water and a filtration unit of filtering the sample water and collecting the particulates for analysis by direct microscopic method are both in operation and abnormality is observed in the result obtained by the measurement unit.

### TECHNICAL FIELD

The present invention relates to a particulate-measuring method and a particulate-measuring system for use in measuring particulates in sample water.

### BACKGROUND ART

Pure water (including ultrapure water) has been used in various industrial fields including semiconductor manufacturing field and medicine manufacturing field. There are recently increasing requirements on the quality of pure water used industrially, and tests and management for assuring that the required water quality is maintained are performed, for example, in primary pure water-manufacturing facilities and ultrapure water-manufacturing facilities. One of the water quality control items in these tests and management is the number of particulates contained in 1 ml of pure water.

Generally for regular particulate control, the number of particulates contained in pure water is measured and monitored with an online particulate counter as a method for controlling the particulates in pure water. For example, Patent Document 1 discloses an ultrapure water-manufacturing apparatus equipped with a particulate counter for measurement of the number of particulates, a TOC meter for measurement of TOC (total organic carbon) value, a resistivity meter for measurement of resistivity and others.

Alternatively, Patent Document 2 discloses a method and an apparatus comprising filtering ultrapure water with a filter and counting the number of particulates collected on the filter under microscope, as a method and an apparatus for determining the number of particulates in ultrapure water. Such a method of measuring the number of particulates, which is called direct microscopic method, is normally used for detailed analysis of particulates in regular tests or in tests under abnormal conditions.

### CITATION LIST

### Patent Literatures

[Patent Document 1] JP-A No. H05-138196

[Patent Document 2] JP-A No. H10-63810

### SUMMARY OF INVENTION

### Technical Problem

Online particulate counters have an advantage that it is possible to measure particulates in pure water easily on time. With the advantage, such an online particulate counter has been used for routine particulate control of monitoring the number of particulates in pure water. However, with such an online particulate counter, real-time measurement becomes harder when the particulates have a smaller particulate diameter and measurement satisfying the increasing requirements on water quality becomes more difficult.

Although the direct microscopic method permits detailed analysis and measurement satisfying the increasing requirements on water quality, it does not permit real-time measurement and demands a longer period for analysis. Accordingly as described above, it is common sense to consider that the direct microscopic method is used only in regular tests or when abnormality is observed, for example when a particular number or more of particulates are detected by the particulate counter.

However if sample water is filtered for analysis by direct microscopic method after abnormality is observed, it may not be possible to collect particulates timely during particulate hunting. It is because the amount of the particulates collected may decrease by time loss when there is hunting of the number of particulates during operation for exchange of filtration membrane or during the period between regular tests. Usually it is determined whether the hunting is caused by particulates or simply by temporal abnormality of the particulate-measuring instrument. Normally hunting that recovers soon is considered not to be abnormal and it may be too late to collect particulates timely when abnormality actually occurs.

Thus, an object of the present invention is to provide a particulate-measuring method and a particulate-measuring system that can collect particulates in sample water timely even when abnormality is observed in the result obtained by a measurement unit for measuring particulates contained in sample water.

### Solution to Problem

The present invention provides a particulate-measuring method including filtering sample water continuously, even when a measurement unit for measuring particulates in sample water and a filtration unit for filtering the sample water and collecting the particulates therein for analysis by direct microscopic method are both in operation and abnormality is observed in the result obtained by the measurement unit.

The particulate-measuring method according to the present invention can collect particulates timely even during abnormality, because the sample water is filtered even when the measurement unit and the filtration unit for analysis by direct microscopic method are both in operation and abnormality is observed in the result obtained by the measurement unit.

The particulate-measuring method according to the present invention can include filtering the sample water continuously by operating the filtration unit continuously even when abnormality is observed in the result measure by the measurement unit.

The particulate-measuring method according to the present invention can include filtering the sample water continuously, as the filtration unit has a first filtration unit and a second filtration unit installed to supply the sample water switchably and, when the measurement unit and the first filtration unit are both in operation and abnormality is observed in the result obtained by the measurement unit, the first filtration unit is inactivated and the second filtration unit activated.

In the particulate-measuring method according to the present invention, the filtration unit filtering the sample water continuously after abnormality is observed in the result obtained by the measurement unit can be inactivated after the abnormality is eliminated. The particulates collected by the filtration unit for filtering the sample water continuously after abnormality is observed in the result obtained by the measurement unit can be analyzed. The analysis of particulates then can be performed by the so-called direct microscopic method using an optical microscope or a scanning electron microscope.

The present invention also provides a particulate-measuring system including a measurement unit for measuring particulates in sample water, a filtration unit for filtering the sample water and collecting the particulates for analysis by direct microscopic method, and a control unit for controlling the system to continue filtering the sample water when the measurement unit and the filtration unit are both in operation and abnormality is observed in the result obtained by the measurement unit.

The control unit can keep the filtration unit continuously in operation even when abnormality is observed in the result obtained by the measurement unit.

The filtration unit has a first filtration unit and a second filtration unit installed to supply the sample water switchably and the control unit can, when the measurement unit and the first filtration unit are both in operation and abnormality is observed in the result obtained by the measurement unit, inactivate the first filtration unit and activate the second filtration unit.

The control unit can inactivate the filtration unit filtering the sample water continuously after abnormality is observed in the result obtained by the measurement unit, after the abnormality is eliminated.

The control unit can determine the abnormality when a particular number or more of the particulates are detected continuously for a particular period of time by the measurement unit.

The present invention further provides a system for manufacturing ultrapure water including the particulate-measuring system according to the present invention in its pure water-manufacturing process.

### Advantageous Effects of Invention

The present invention provides a particulate-measuring method and a particulate-measuring system that can collects particulates in sample water timely even when abnormality is observed in the result obtained by a measurement unit for measuring particulates in sample water.

### BRIEF DESCRIPTION OF DRAWINGS

FIG. 1 is a system diagram showing a configuration of a particulate-measuring system to which a particulate-measuring method described in the first embodiment of the present invention is applied.

FIG. 2 is a flowchart showing the particulate-measuring method described in the first embodiment of the present invention.

FIG. 3 is a system diagram showing a configuration of the particulate-measuring system to which the particulate-measuring method described in the second embodiment of the present invention is applied.

FIG. 4 is a flowchart showing the particulate-measuring method described in the second embodiment of the present invention.

FIG. 5 is a system diagram showing a configuration of ultrapure water-manufacturing facilities to which the particulate-measuring system according to the present invention is applied.

### DESCRIPTION OF EMBODIMENTS

Hereinafter, favorable embodiments of the invention will be described in detail. It should be understood that the present invention is not limited to the embodiments described below.

A particulate-measuring method disclosed herein includes filtering the sample water continuously, even when both a measurement unit for measuring particulates in sample water and a filtration unit for filtering the sample water and thus collecting the particulates for analysis by direct microscopic method are in operation and abnormality is observed in the result obtained by the measurement unit.

The particulate-measuring method disclosed herein includes filtering sample water continuously even when the measurement unit and the filtration unit are both in operation and abnormality is observed in the result obtained by the measurement unit timely. Thus, even when the result obtained by the measurement unit is abnormal, it is possible to collect particulates in sample water. As it is possible to collect the particulates timely, it is possible to reduce the number of uncollected particulates (loss number) and increase the amount of the particulates collected. It is thus possible to analyze in detail the collected particulates by direct microscopic method. Thus, it is possible according to the particulate-measuring method disclosed herein to identify rapidly the reason for the abnormality of the measurement results by the measurement unit and improve the quality in managing the particulates in pure water.

The particulate-measuring method disclosed herein can be realized by a control unit, by storing the steps (procedure) of the method as a program, for example, in a control unit such as CPU of an apparatus of controlling the size (particulate diameter), number and others of the particulates to be measured (e.g., personal computer or the like) and a hardware resource equipped with a memory medium (e.g., USB memory, HDD or CD).

The particulate-measuring method disclosed herein can be executed, as it is applied to a particulate-measuring system equipped with a control unit.

The particulate-measuring system includes a measurement unit for measuring particulates in sample water, a filtration unit for filtering the sample water and thus collecting the particulates therein for analysis by direct microscopic method, and a control unit for controlling the system to continue filtration of the sample water when abnormality is observed in the result obtained by the measurement unit in a state measurement unit and filtration unit are both in operation.

The particulate-measuring method and the particulate-measuring system disclosed herein can be applied to a primary pure water-manufacturing system, more favorably to a system for manufacturing ultrapure water (also called secondary pure water-manufacturing system and subsystem) that further purifies the pure water prepared by a primary pure water-manufacturing system.

The primary pure water-manufacturing system is a system to produce pure water and examples thereof include ion-exchange resins, reverse osmosis membranes, systems in combination thereof, and the like.

The secondary pure water-manufacturing system is a system including, for example, a heat exchanger, an ultraviolet oxidation apparatus, an ion exchange apparatus and/or an ultrafiltration apparatus in combination.

Examples of the sample water to be analyzed by the particulate-measuring method and the particulate-measuring system disclosed herein include, but are not particularly limited to, pure water in the production process of the primary pure water-manufacturing system and ultrapure water in the production process of the secondary pure water-manufacturing system. Examples of the “sample water” include the pure water and the ultrapure water above and water from which impurities such as ionic components, organic matters and particulates are desirably removed.

The particulate-measuring method and the particulate-measuring system disclosed herein will be described in detail in the following first to third embodiments.

### First Embodiment

A particulate-measuring method of the first embodiment is a method wherein, even when a particulate-measuring instrument as the measurement unit and a filter as the filtration unit are both in operation and abnormality is observed in the result obtained by the measurement unit, filtration is carried out continuously, as the filter is kept in operation continuously.

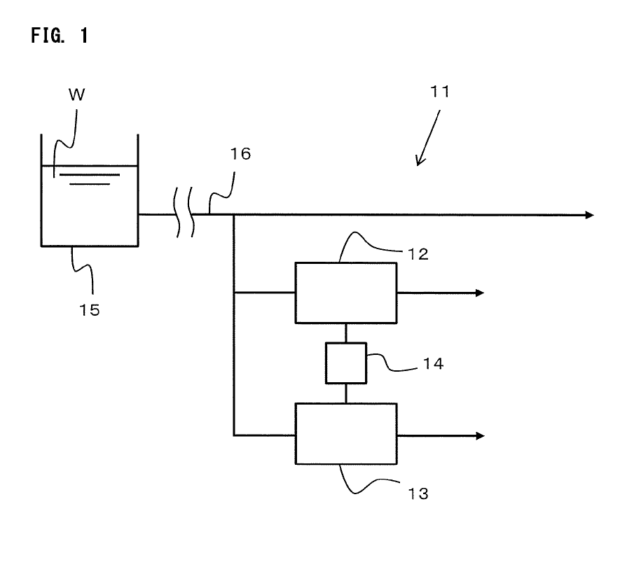

FIG. 1 is a system diagram showing a configuration of the particulate-measuring system to which the particulate-measuring method of the present embodiment is applied (particulate-measuring system of the first embodiment).

The particulate-measuring system 11 of the present embodiment includes a particulate-measuring instrument 12, a filter 13, and a control unit 14. In the present embodiment, the particulate-measuring instrument 12 and the filter 13 are connected to the system, as they are branched from a pipe 16 in which sample water W stored in a reservoir 15 (pure water in the present embodiment) flows.

The particulate-measuring instrument 12 is preferably an online light-scattering-type automatic particulate-measuring instrument using, for example, a commercially available laser scattering light.

The particulate-measuring instrument 12 determines at least the number of particulates contained in the pure water W, as it is fed therein from the pipe 16. The particulate-measuring instrument 12 of the present embodiment can determine the number and size (particulate diameter) of the particulates in the pure water continuously. The particulates therein are counted by the particulate-measuring instrument 12 according to the “Measuring method by automatic particulate-measuring instrument” of JIS K0554 (Testing methods for concentration of fine particulates in highly purified water).

The particulate-measuring instrument 12 displays the number of the particulates present in a unit volume of water (unit: pieces/ml) on a monitor as the measured value, and measures and monitors on time (real time) the number of particulates contained in the pure water continuously. The particulate-measuring instrument 12 determines whether the number of the particulates measured is normal or abnormal.

The “abnormality” of the result obtained by the particulate-measuring instrument 12 is determined based on the required water quality, for example, based on the diameter and the number of the measured particulates and the period of observation.

For example when a particular number or more of the particulates is observed for a particular period of time or longer by the particulate-measuring instrument 12, the value is considered to be “abnormal.” The “particular number” of the particulates measured by the particulate-measuring instrument 12 is, for example, in the range of 100 to 10000 pieces/L (favorably 500 to 5000 pieces/L). Similarly, the “particular period of time” is, for example, in the range of 30 seconds to 30 minutes (favorably 1 minute to 10 minutes). In a typical example of the system for manufacturing ultrapure water favorably designed in the ranges above, when, for example, 1000 pieces/L or more of particulates are detected continuously for 5 minutes or longer by the particulate-measuring instrument 12, the result is considered to be “abnormal.”

The filter 13, which filters the pure water supplied from the pipe 16 and collects particulates for analysis by the direct microscopic method, has a filtration membrane for collecting particulates. The filter 13 collects particulates having a diameter smaller than those hardly measurable by the particulate-measuring instrument 12 with its filtration membrane and supplies the particulates for direct microscopic analysis. The direct microscopic method can analyze, for example, the size (particulate diameter), number, composition and others of the particulates.

The filter 13 is not particularly limited, if it can collect particulates in pure water W with its filtration membrane. Examples of such usable filters 13 include centrifugal filters and membrane separation units using through water pressure (water supply pressure).

The membrane separation unit using through water pressure is a unit including a separation membrane (filtration membrane) wherein the driving force of filtration is supplied by through water pressure. Since the driving force for filtration is supplied by through water pressure, water should be supplied for an elongated period of time for production of a needed amount of filtered water, but such a unit is favorable, as it can be installed easily.

The centrifugal filter, which uses centrifugal force for filtration, is more favorable than the membrane separation unit using through water pressure, as it produces a needed amount of filtered water in a short period of time. The filter 13 used in the present embodiment is a centrifugal filter 13.

The filtration period of the filter 13 used in the particulate-measuring method and the particulate-measuring system 11 disclosed herein is not particularly limited and may be determined arbitrarily according to the required water quality.

For example when the required water quality is one particulate having a diameter of 0.05 μm or more in 1 ml, the filtration period is 20 days of more at a pressure of 2 MPa in the case of a centrifugal filter, while it is desirably 100 days or more at a pressure of 0.4 MPa in the case of filtration by through water pressure.

The filtration period described above varies according to the blank value of filtration membrane used in the filter 13 during its preparation, the number of visual fields during analysis by microscopic observation, the diameter of the particulates collected, the expected concentration of the particulates and others.

The filtration membrane used in the filter 13 may be a commercial product that is normally used in the field of pure water production. The filtration membrane is not particularly limited, if it can collects particulates to be measured on the surface and has a structure permitting passage of the sample water.

Examples of the filtration membranes, as classified by pore size, include microfiltration membranes (MF membranes), ultrafiltration membranes (UF membranes), and reverse osmosis membranes (RO membranes) and the like. Examples of the filtration membranes, as classified by structure, include hollow fiber membranes, spiral membranes, tubular membranes and the like. Examples of the materials for the filtration membrane include cellulose acetate, aromatic polyamides, polyvinylalcohol, polyvinylidene fluoride, polyethylene, polyacrylonitrile, polypropylene, polycarbonates, polytetrafluoroethylene, ceramics and the like.

The control unit 14 has at least a function of controlling the filter 13. The control unit 14 is a unit controlling the system to continue filtration of pure water by keeping the filter 13 continuously in operation even when the particulate-measuring instrument 12 and the filter 13 are both in operation and the result obtained by the particulate-measuring instrument 12 is found to be abnormal. The control unit 14 may be integrated with the filter 13 or formed separately from the filter 13.

The control unit 14 may have a function of controlling the filter 13 and also the particulate-measuring instrument 12. For example, the possible is a configuration in which: the particulate-measuring instrument 12 and the control unit 14 are both in operation; the result obtained by the particulate-measuring instrument 12 is outputted to the control unit 14; and the control unit 14 determines whether the measured result is abnormal or not.

For example in determination of abnormality by the control unit 14, normal and abnormal values of measurement results may be stored in a memory medium operating in concert with the control unit 14 and the control unit 14 determines abnormality, based on the data of normal and abnormal values of measurement results stored in the memory medium.

In consideration of the cases where abnormality of the result obtained by the particulate-measuring instrument 12 disappears soon or where abnormal by nonconformity of the particulate-measuring instrument 12 itself is observed, it is preferable that the control unit 14 determines abnormality only when a particular number of more of particulates are observed continuously for a particular period of time or longer. It is possible in this way to determine only true abnormality derived from the number, size and others of the particulates determined by the particulate-measuring instrument 12. The “particular number” and the “particular period of time” can be specified arbitrarily within the range described in the “abnormality” of the result obtained by the particulate-measuring instrument 12 described above. The “particular number” and the “particular period of time” described below can also be specified similarly.

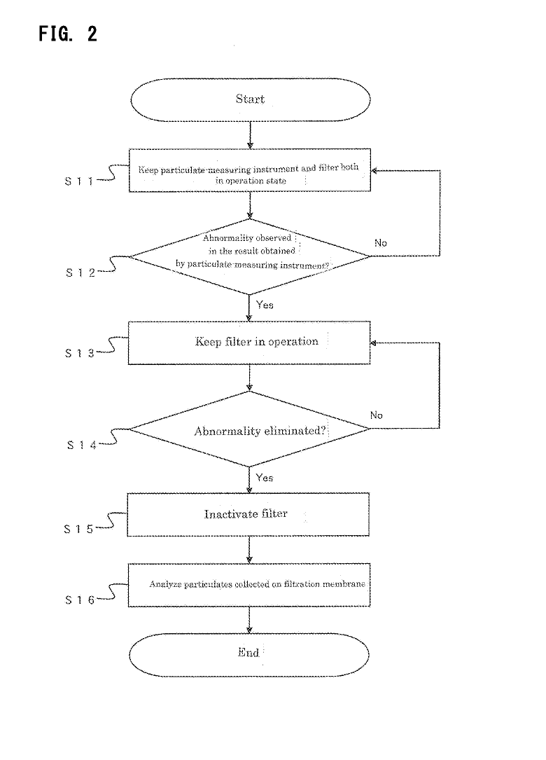

FIG. 2 is a flowchart showing the particulate-measuring method of the present embodiment. The flowchart shows operation of the particulate-measuring system 11 of the present embodiment described above.

In FIG. 2, it is assumed before the start of the particulate-measuring method of the present embodiment that pure water W is already fed into the particulate-measuring instrument 12 and the filter 13.

In the particulate-measuring method of the present embodiment, the particulate-measuring instrument 12 and the filter 13 are both in operation (Step S11). The particulate-measuring instrument 12 and the filter 13 need not be simultaneously activated, if the particulate-measuring instrument 12 and the filter 13 are both in the operation state.

The operation state of the particulate-measuring instrument is a state wherein sample water is fed into the particulate-measuring instrument and particulates contained in the sample water are measured by the particulate-measuring instrument. The operation state of the filter is a state wherein pure water is fed into the filter and the sample water is filtered. Then, if there are particulates contained in the sample water, the particulates are collected.

The rotational frequency, pressure, and continuous operation period (continuous operation hours or days in one cycle) of the filter 13 are selected arbitrarily, for example, according to the sample water to be analyzed and the site to which the particulate-measuring method disclosed herein is applied.

Then, abnormality of the result obtained by the particulate-measuring instrument 12 is examined (Step S12). The abnormality may be determined by the control unit described above.

For example, the possible is a configuration wherein: the particulate-measuring instrument 12 and the control unit 14 are both in operation; the result obtained by the particulate-measuring instrument 12 is outputted to the control unit 14; and the control unit 14 determines whether the measurement result is abnormal or not.

For example in determination of abnormality by the control unit 14, normal and abnormal values of measured results may be stored as threshold values or numerical ranges in memory medium operating in concert with the control unit 14, and the control unit 14 may determine abnormality based on the data of the normal and abnormal values of measured result stored in the memory medium.

In consideration of the cases where the abnormality of the result obtained by the particulate-measuring instrument 12 disappears soon or where abnormality by nonconformity of the particulate-measuring instrument 12 itself is observed, it is preferable that the control unit 14 determines abnormality only when a particular number of more of particulates are observed continuously for a particular period of time or longer. It is possible in this way to determine only true abnormality derived from the number, size and others of the particulates determined by the particulate-measuring instrument 12.

If abnormality is observed in Step S12, filtration is continued by the filter 13 (Step S13). Alternatively if abnormality is not observed in Step S12, the particulate-measuring instrument 12 and the filter 13 are both in the operation state and they are kept in operation consistently (Step S11).

The “consistent” operation of the filter 13 includes the case where it is operated continuously for a cycle of arbitrary hours (days). After a cycle of continuous operation of the filter 13, the filtration membrane of the filter 13 is preferably exchanged and the filter resumes continuous operation within several tens of minutes (e.g., 30 minutes).

After abnormality is observed in the result obtained by the particulate-measuring instrument 12, the filter 13 continuously in operation is inactivated within a particular period of time (Step S15).

For reliable collection of the particulates during abnormality by the filter 13 (Step S14), the time when the filter 13 is inactivated is preferably the time when the abnormality is eliminated. In this case, as elimination of the abnormality is the precondition for inactivation of the filter 13, it is preferable to determine whether the abnormality is eliminated or not. This decision can also be made by the control unit 14.

Alternatively, the time when the filter 13 is inactivated may be a particular time after abnormality is observed or a time when a particular filtration amount of water is filtered. The particular time or the particular filtration amount is preferably a time or filtration amount sufficient for elimination of abnormality, which varies according to the required water quality and the sample water to be analyzed.

After the filter 13 is inactivated, the filtration membrane is separated from the filter 13 and the particulates collected on the filtration membrane are analyzed and measured by direct microscopic method, for example, under an optical microscope or a scanning electron microscope (SEM) (Step S16).

The direct microscopic method is a method of determining the number of particulates by filtering sample water (pure water) of which the number of particulates is determined, with a filtration membrane that can collect particulates of the desired size, thus collecting the particulates and counting the particulates present in the sample, as they are expanded under microscope. The direct microscopic method is performed according to the “Measuring method under optical microscope” or the “Measuring method under scanning electron microscope” of JIS K0554 (Testing methods for concentration of fine particulates in highly purified water).”

It is also possible to analyze the composition of the particulates by observing the particulates under scanning electron microscope using an apparatus in which a scanning electron microscope is equipped with an X-Ray analyzer such as energy dispersive X-Ray spectrometer (EDX).

As described above in detail, it is possible by the particulate-measuring method and the particulate-measuring system 11 of the first embodiment to collect particulates properly during abnormality, as the filter 13 is kept in operation continuously even when the particulate-measuring instrument 12 and the filter 13 for analysis by direct microscopic method are both in operation and abnormality is observed in the measurement result of the particulate-measuring instrument 12. It is thus possible to decrease the number of uncollected particulates and increase the amount of particulates collected. It is thus possible to analyze the particulates in detail by direct microscopic method, to rapidly identify the reason for abnormality of the result obtained by the particulate-measuring instrument 12 and to improve the quality in controlling particulates in pure water.

In the particulate-measuring system 11 of the present embodiment, the pure water supplied to the particulate-measuring instrument (measurement unit) 12 and the filter (filtration unit) 13 may be discharged as wastewater or recovered through a recovery line into a raw water tank or a processed water tank and reused as part of the raw water. The pure water supplied to the measurement units and the filtration units in the second and third embodiments can also be processed similarly.

### Second Embodiment

A particulate-measuring method and the particulate-measuring system of the second embodiment are different from those of the first embodiment in that two filters are used as the filtration unit of collecting particulates for analysis by direct microscopic method.

In the particulate-measuring method of the second embodiment, a first filtration unit (first filter) and a second filtration unit (second filter) are used as the filtration unit, as they are installed in such a configuration that they can supply sample water (pure water in the present embodiment) switchably.

In the particulate-measuring method of the present embodiment, when the particulate-measuring instrument as the measurement unit and the first filter are both in operation and abnormality is observed in the result obtained by the particulate-measuring instrument, the first filter is inactivated and the second filter is activated.

In the particulate-measuring method of the present embodiment, pure water is filtered continuously, by using the first and second filters.

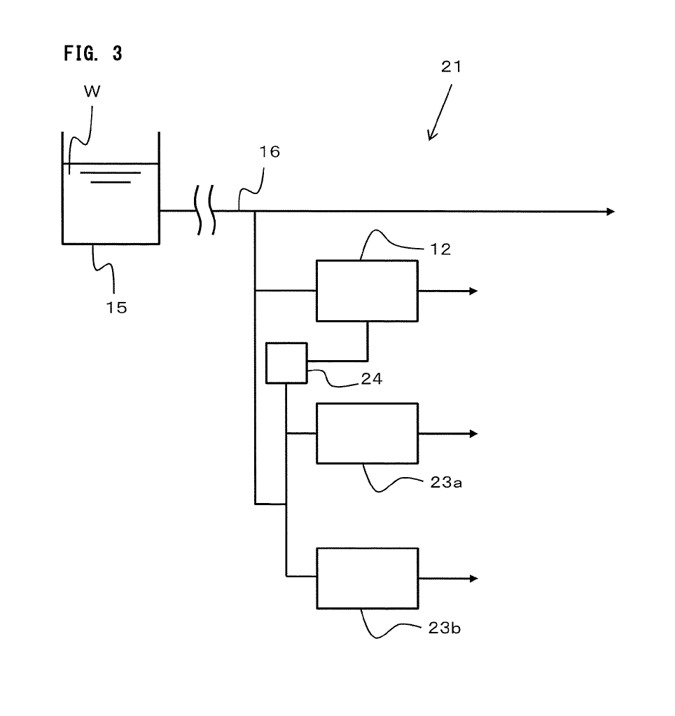

FIG. 3 is a system diagram showing a configuration of a particulate-measuring system 21 to which the particulate-measuring method of the present embodiment is applied (the particulate-measuring system 21 of the second embodiment).

The particulate-measuring system 21 of the present embodiment includes a particulate-measuring instrument 12, a first filter 23a, a second filter 23b, and a control unit 24. In the present embodiment, the particulate-measuring instrument 12, the first filter 23a and the second filter 23b are connected to the system, as they are branched from a pipe 16 in which sample water (pure water) W stored in a reservoir 15 flows.

The particulate-measuring instrument 12 used in the present embodiment is similar to the particulate-measuring instrument 12 used in the first embodiment. The first filter 23a and the second filter 23b used in the present embodiment are both similar to the filter 13 used in the first embodiment, but are different from the filter of the first embodiment in the controlling method by the control unit 24. Although centrifugal filters 23a and 23b are also used as the first filter 23a and the second filter 23b in the present embodiment, other filters such as membrane separation units may be used instead.

In the present embodiment, the control unit 24 has a function of controlling at least the first filter 23a and the second filter 23b. When the particulate-measuring instrument 12 and the first filter 23a are both in operation and abnormality is observed in the result obtained by the particulate-measuring instrument 12, the control unit 24 inactivates the first filter 23a and activates the second filter 23b, controlling the system to filter pure water W continuously.

The control unit 24 may be connected to the first filter 23a and/or second filter 23b, or formed separately from the first filter 23a and the second filter 23b.

The control unit 24 may have a function of controlling the particulate-measuring instrument 12 in addition to the first filter 23a and the second filter 23b.

For example, the possible is a configuration in which: the particulate-measuring instrument 12 and the control unit 24 are both in operation; the result obtained by the particulate-measuring instrument 12 is outputted to the control unit 24, and the control unit 24 determines whether the measurement results is abnormal or not. When the particulate-measuring instrument 12 and the control unit 24 are both in operation in this way, abnormality of the result obtained by the particulate-measuring instrument 12 can be determined accurately and rapidly.

For example in determination of abnormality by the control unit 24, normal and abnormal values of measurement result may be stored in a memory medium operating in concert with the control unit 24 and the control unit 24 may determine abnormality, based on the data of the normal and abnormal values of measurement results stored in the memory medium.

In consideration of the cases where the abnormality of the result obtained by the particulate-measuring instrument 12 disappears soon or where abnormality by nonconformity of the particulate-measuring instrument 12 itself is observed, it is preferable that the control unit 24 determines abnormality only when a particular number or more of particulates are observed continuously for a particular period of time or longer. It is possible in this way to determine only true abnormality derived from the number, size and others of the particulates determined by the particulate-measuring instrument 12.

When the abnormality of the result obtained by the particulate-measuring instrument 12 disappears, the control unit 24 can control the system to inactivate the second filter 23b that was activated to continue filtration and reactivate the first filter 23a that was inactivated.

With the control unit 24 controlling the first filter 23a and the second filter 23b in this way, the first filter 23a filters the sample water if the result obtained by the particulate-measuring instrument 12 is normal and the second filter filters the sample water if the result obtained by the particulate-measuring instrument 12 is abnormal. Thus, the first filter 23a may be used in the normal condition, while the second filter 23b is used in the abnormal condition.

When the first filter 23a is used in the normal condition and the second filter 23b is used in the abnormal condition, if the abnormality of the particulate-measuring instrument 12 disappears, the second filter 23b is inactivated, the filtration membrane of the second filter 23b is separated and the particulates collected on the filtration membrane are analyzed. As the first filter 23a is kept in operation during the period, it is possible to collect particulates even in the normal condition.

Control of the first filter 23a and the second filter 23b by the control unit 24 can be performed, for example, by switching supply of the sample water W to the filters 23a and 23b. More specifically, a switching valve (not shown in Figure) may be installed to filters 23a and 23b at a position where the sample water W is supplied from the pipe 16 so that the control unit 24 controls the switching valve to activate and inactivate the first filter 23a and the second filter 23b.

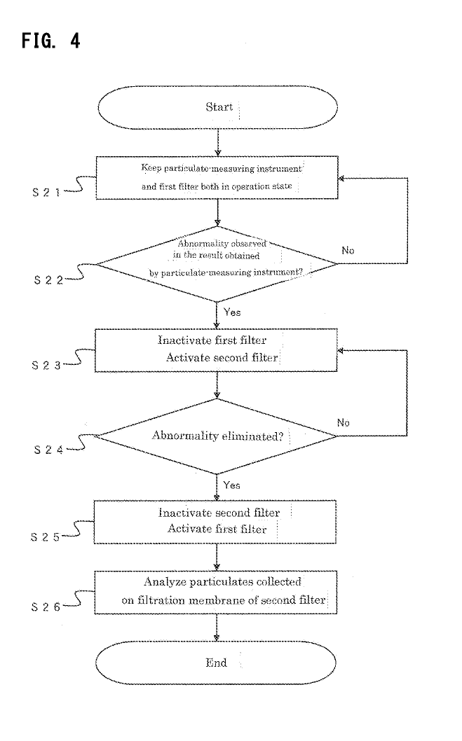

FIG. 4 is a flowchart showing the particulate-measuring method of the present embodiment. The flowchart also shows operation of the particulate-measuring system 21 of the present embodiment described above.

In FIG. 4, it is assumed before the start of the particulate-measuring method of the present embodiment that pure water W is already fed into the particulate-measuring instrument 12 and the first filter 23a.

In the particulate-measuring method of the present embodiment, the particulate-measuring instrument 12 and the first filter 23a are both in operation (Step S21). The particulate-measuring instrument 12 and the first filter 23a need not be activated simultaneously, if the particulate-measuring instrument 12 and the first filter 23a are both in the operation state.

The rotational frequency, pressure and one-cycle continuous operation period of the first filter (centrifugal filter) 23a are selected arbitrarily, for example, according to the sample water analyzed and the site to which the particulate-measuring method disclosed herein is applied.

Then, abnormality of the result obtained by the particulate-measuring instrument 12 is examined (Step S22). The abnormality may be determined by the control unit 24 in a similar manner described in the first embodiment. In determination by the control unit 24, the control unit 24 may be configured to operate in concert with the memory medium.

Similarly to the first embodiment, it is preferable for the control unit 24 to determine abnormality only when a particular number or more of particulates is observed continuously for a particular period of time or longer. It is possible in this way to determine only true abnormality derived from the number, size, and others of the particulates determined by the particulate-measuring instrument 12.

When abnormality is observed in Step S22, the first filter 23a is inactivated and the second filter 23b is activated (Step S23). In this way, the system keeps filtration continuously even when abnormality is observed by the particulate-measuring instrument 12. Inactivation of the first filter 23a and activation of the second filter 23b are performed by the control unit 24, as it controls the first filter 23a and the second filter 23b. The rotational frequency and the filtration pressure of the second filter (second centrifugal filter) 23b can also be selected arbitrarily, but are preferably similar to those of the first filter 23a for continuous filtration from the first filter 23a.

As for the timing for the inactivation of the first filter 23a and activation of the second filter 23b, the second filter 23b is preferably activated immediately after the first filter 23a is inactivated and, more preferably, the first filter 23a is inactivate and the second filter 23b activated almost at the same time. Such linked operation of the first filter 23a and the second filter 23b reduces time loss and the number of particulates uncollected (loss number) and increases the amount of particulates collected.

The particulate-measuring instrument 12 and the first filter 23a remain in the operation state even when abnormality is not observed in Step S22, and they are always in the operation state in the normal condition (Step S21).

Then, the second filter 23b, which remains in operation after abnormality of the result obtained by the particulate-measuring instrument 12 is observed, is inactivated and the first filter 23a reactivated after a particular period of time (Step S25).

For reliable collection of the particulates by the second filter 23b during abnormality, the second filter 23b is preferably inactivated when the abnormality is eliminated. In this case, as elimination of the abnormality is the precondition for inactivation of the second filter 23b, it is preferable to determine whether the abnormality is eliminated (Step S24). This decision can also be made by the control unit 24.

The second filter 23b may be inactivated at particular time after the abnormality is observed. The particular time is preferably a time sufficient for removal of abnormality, which varies according to the required water quality and the sample water to be analyzed.

After inactivation of the second filter 23b, the filtration membrane is separated from the second filter 23b and the number, size (particulate diameter), composition and the like of the particulates collected on the filtration membrane are analyzed and measured by direct microscopic method similarly to the method described in the first embodiment (Step S26).

As described above in detail, according to the particulate-measuring method and the particulate-measuring system 21 of the second embodiment, wherein the first filter 23a is inactivated and the second filter 23b is activated when the particulate-measuring instrument 12 and the first filter 23a are both in operation and abnormality is observed in the particulate-measuring instrument 12, particulates are collected properly even during abnormality. It is thus possible to reduce the number of particulates uncollected and increase the amount of particulates collected. The collected particulates are then analyzed in detail by the direct microscopic method, making it possible to rapidly identify the reason for the abnormality of the result obtained by the particulate-measuring instrument 12 and to improve the quality in controlling particulates in pure water.

It is also possible, by using the first filter 23a as a filter in the normal condition and the second filter 23b as a filter in the abnormal condition, to keep the first filter 23a in operation even during analysis of the particulates collected by the second filter 23b by the direct microscopic method and to monitor the particulates in pure water consistently.

### Third Embodiment

Hereinafter, an embodiment of an ultrapure water-manufacturing system employing the particulate-measuring method and the particulate-measuring system disclosed herein will be described as an example.

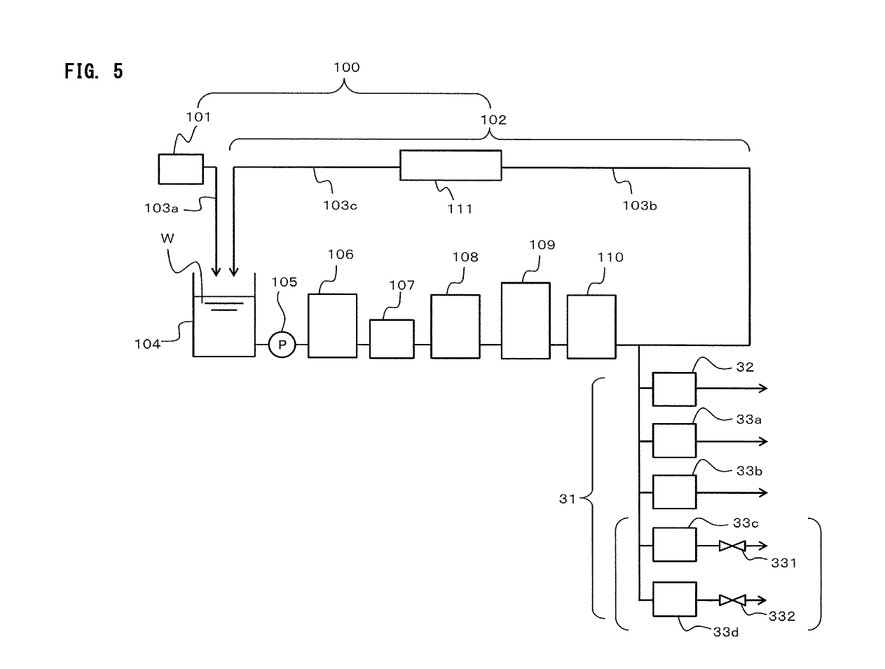

FIG. 5 is a system diagram showing a configuration explaining ultrapure water-manufacturing facilities 100 of the present embodiment. The ultrapure water-manufacturing facilities 100 described in the present embodiment includes a primary pure water-manufacturing system 101 and a system for manufacturing ultrapure water (also called subsystem or secondary pure water-manufacturing system) 102.

The ultrapure water-manufacturing facility 100 is a facility of producing ultrapure water by producing pure water with a primary pure water-manufacturing system 101 and further purifying the produced pure water with the system for manufacturing ultrapure water 102.

The primary pure water-manufacturing system (primary pure water-manufacturing process) 101 is an apparatus that is installed upstream of the system for manufacturing ultrapure water (ultrapure water-manufacturing process) 102 and supplies sample water (pure water) W to the system for manufacturing ultrapure water 102. There is normally a pretreatment apparatus (pretreatment process, not shown in Figure) installed upstream of the primary pure water-manufacturing system 101. In the pretreatment process, most of suspended solids and part of organic matters contained in the raw water to be treated (industrial water, tap water and well water, etc.) are removed for reduction of the load to the downstream primary pure water-manufacturing process. The configuration of the pretreatment apparatus is not particularly limited and examples thereof include aggregation filtration, aggregation precipitation filtration, aggregation pressure-flotation filtration, membrane filtration and the like.

The configuration of the primary pure water-manufacturing system 101 is not particularly limited either, and such a primary pure water-manufacturing system may have a reverse osmosis (RO) membrane separation apparatus, an ion exchange apparatus, a demineralization apparatus, an adsorption apparatus, an organic matter-decomposing apparatus (ultraviolet oxidation apparatus, etc.), a deaeration apparatuses and/or a sterilization apparatuses, as connected to each other in arbitrary order.

The system for manufacturing ultrapure water (ultrapure water-manufacturing process) 102 is a system of purifying further the pure water W obtained by the primary pure water production process 101 and generally has a heat exchanger, an ultraviolet oxidation apparatus, an ion exchange apparatus, an ultrafiltration apparatus and the like in combination.

In the system for manufacturing ultrapure water 102 of the present embodiment, the primary pure water W produced by the primary pure water-manufacturing system 101 is fed through a pipe 103a into a reservoir 104. The water is then withdrawn by a feed pump 105 and processed in a heat exchanger 106, a low-pressure ultraviolet oxidation apparatus 107, a deaeration apparatus 108, an ion exchange apparatus 109, and an ultrafiltration (UF) membrane apparatus 110 sequentially. The system for manufacturing ultrapure water 102 supplies the ultrapure water obtained after the treatment through a pipe 103b to a use point 111, and the excess water through a pipe 103c to the reservoir 104.

The system for manufacturing ultrapure water 102 has a particulate-measuring system 31 disclosed herein. The place of the system for manufacturing ultrapure water 102 where the particulate-measuring system 31 is installed is not particularly limited. In the present embodiment, a particulate-measuring system 21 is installed downstream of the UF membrane apparatus 110, as branched from a pipe 103b in which the water treated in the UF membrane apparatus 110 (ultrapure water) flows, in the system for manufacturing ultrapure water 102. It is configured that the water (ultrapure water) treated in the UF membrane apparatus 110 is fed into the particulate-measuring system 31.

The particulate-measuring system 31 has a particulate-measuring instrument (measurement unit) 32, filters (filtration units) 33a and 33b, and a control unit (not shown in Figure). The filters 33a and 33b used may be a first centrifugal filter 33a and a second centrifugal filter 33b that are applicable to the particulate-measuring method and the particulate-measuring system of the second embodiment. The operation of the first filter 33a and the second filter 33b is the same as that described in the second embodiment.

If the particulate-measuring method and the particulate-measuring system described in the first embodiment is applied to the ultrapure water-manufacturing facilities 100 (ultrapure water-manufacturing system 102) shown in FIG. 5, the second filter 33b is removed.

In the ultrapure water-manufacturing facilities 100 (system for manufacturing ultrapure water 102) shown in FIG. 5, membrane separation units using through water pressure (water supply pressure) (i.e., first membrane separation unit 33c and second membrane separation unit 33d) may be used replacing the first centrifugal filter 33a and the second centrifugal filter 33b (shown in parentheses in FIG. 5). When the membrane separation units 33c and 33d are used, it is preferable to install on-off valves 331 and 332 that can switch activation and inactivation of filtration by the membrane separation units 33c and 33d.

In this case, the first membrane separation unit 33c is used for operation in the normal condition, while the second membrane separation unit 33d is used for operation in the abnormal condition. When the particulate-measuring instrument 32 and the first membrane separation unit 33c are both in operation and abnormality is observed in the result obtained by the particulate-measuring instrument 32, the first on-off valve 331 downstream of the first membrane separation unit 33c is switched from open to closed, while the second on-off valve 332 downstream of the second membrane separation unit 33d, which was closed, is switched from closed to open. The first on-off valve 331 and the second on-off valve 332 may be both controlled by the control unit (not shown in Figure) and the control unit may open or close the first on-off valve 331 and the second on-off valve 332 automatically in concert with the particulate-measuring instrument 32.

As described above in detail, the system for manufacturing ultrapure water 102 (ultrapure water-manufacturing facility 100) of the third embodiment, which has the particulate-measuring system 31 disclosed herein, can exhibit the advantageous effects of the particulate-measuring system 31. In addition, as the particulate-measuring system 31 collects particulates at an adequate timing, it is possible to improve the water quality (quality) of the ultrapure water produced. Thus, the system for manufacturing ultrapure water 102 of the present embodiment is favorably used in various industrial fields including semiconductor- and medicine-manufacturing fields.

The particulate-measuring method and the particulate-measuring system disclosed herein may have the configurations below.

The particulate-measuring systems exemplified in the embodiments above may have additionally various measuring instruments such as dissolved gas densitometer, TOC meter, hydrogen peroxide densitometer, silica meter, boron meter, evaporation residue meter, and water temperature gauge as water quality-monitoring units.

A configuration containing two filters was shown in the second and third embodiments, but the number of the filters may be more than 2. In this case, it is preferable to install a control unit that can control each of the filters.

The present invention may have the following configurations:

[1] A particulate-measuring method including filtering the sample water continuously, even when a measurement unit for measuring particulates in sample water and a filtration unit for filtering the sample water and collecting the particulates therein for analysis by direct microscopic method are both in operation and abnormality is observed in the result obtained by the measurement unit.
[2] The particulate-measuring method according to [1] above, wherein the filtration unit is kept in operation even when abnormality is observed in the result obtained by the measurement unit.
[3] The particulate-measuring method according to [1] above, wherein the filtration unit has a first filtration unit and a second filtration unit installed to supply the sample water switchably, and when the measurement unit and the first filtration unit are both in operation and abnormality is observed in the result obtained by the measurement unit, the first filtration unit is inactivated and the second filtration unit is activated.
[4] The particulate-measuring method according to any one of [1] to [3] above, wherein the filtration unit that remains filtering continuously after abnormality is observed in the result obtained by the measurement unit is inactivated when the abnormality is eliminated.
[5] The particulate-measuring method according to any one of [1] to [4] above, wherein particulates collected by the filtration unit that remains filtering continuously after abnormality is observed in the result obtained by the measurement unit are analyzed.
[6] The particulate-measuring method according to any one of [1] to [5] above, wherein the abnormality is determined when a particular number or more of the particulates are detected continuously for a particular period of time by the measurement unit.
[7] A particulate-measuring system using the particulate-measuring method according to any one of [1] to [6] above.
[8] A particulate-measuring system, including a measurement unit for measuring particulates in sample water, a filtration unit for filtering the sample water and collecting the particulates for analysis by direct microscopic method, and a control unit for controlling the system to continue filtering the sample water when the measurement unit and the first filtration unit are both in operation and abnormality is observed in the result obtained by the measurement unit.
[9] The particulate-measuring system according to [8] above, wherein the control unit keeps the filtration unit continuously in operation continuously even when abnormality is observed in the result obtained by the measurement unit.
[10] The particulate-measuring system according to [8] above, wherein the filtration unit has a first filtration unit and a second filtration unit installed to supply the pure water switchably, and the control unit inactivates the first filtration unit and activates the second filtration unit when the measurement unit and the first filtration unit are both in operation and abnormality is observed in the result obtained by the measurement unit.
[11] The particulate-measuring system according to any one of [8] to [10] above, wherein the control unit inactivates the filtration unit that keeps filtering continuously after abnormality is observed in the result obtained by the measurement unit, after the abnormality is eliminated.
[12] The particulate-measuring system according to any one of [8] to [11] above, wherein the control unit determines the abnormality when a particular number or more of the particulates are detected by the measurement unit continuously for a particular period of time.
[13] A system for manufacturing ultrapure water using the particulate-measuring method according to any one of [1] to [6] above in the ultrapure water-manufacturing process.
[14] A system for manufacturing ultrapure water including the particulate-measuring system according to any one of [8] to [12] above in the ultrapure water-manufacturing process.

### REFERENCE SIGNS LIST

11, 21, 31: Particulate-measuring system
12: Particulate-measuring instrument
13: Filter
23: First filter
23b: Second filter
14, 24: Control unit
100: Ultrapure water-manufacturing facility
101: Primary pure water-manufacturing system
102: System for manufacturing ultrapure water

1. A particulate-measuring method comprising filtering sample water continuously,
even when a measurement unit for measuring particulates in sample water and a filtration unit for filtering the sample water and collecting the particulates for analysis by direct microscopic method are both in operation and abnormality is observed in the result obtained by the measurement unit.

2. The particulate-measuring method according to claim 1, wherein the filtration unit is kept in operation even when abnormality is observed in the result obtained by the measurement unit.

3. The particulate-measuring method according to claim 1, wherein
the filtration unit has a first filtration unit and a second filtration unit installed to supply the sample water switchably and,
when the measurement unit and the first filtration unit are both in operation and abnormality is observed in the result obtained by the measurement unit, the first filtration unit is inactivated and the second filtration unit is activated.

4. The particulate-measuring method according to claim 1, wherein the filtration unit that remains filtering continuously after abnormality is observed in the result obtained by the measurement unit is inactivated after the abnormality is eliminated.

5. The particulate-measuring method according to claim 1, wherein the particulates collected by the filtration unit that remains filtering continuously after abnormality is observed in the result obtained by the measurement unit are analyzed.

6. A particulate-measuring system, comprising
a measurement unit for measuring particulates in sample water,
a filtration unit for filtering the sample water and collecting the particulates for analysis by direct microscopic method, and
a control unit for controlling the system to continue filtering the sample water when the measurement unit and the filtration unit are both in operation and abnormality is observed in the result obtained by the measurement unit.

7. The particulate-measuring system according to claim 6, wherein the control unit keeps the filtration unit continuously in operation even when abnormality is observed in the result obtained by the measurement unit.

8. The particulate-measuring system according to claim 6, wherein the filtration unit has a first filtration unit and a second filtration unit installed to supply the sample water switchably, and the control unit inactivates the first filtration unit and activates the second filtration unit when the measurement unit and the first filtration unit are both in operation and abnormality is observed in the result obtained by the measurement unit.

9. The particulate-measuring system according to claim 6, wherein the control unit inactivates the filtration unit continuously filtering the sample water after abnormality is observed in the result obtained by the measurement unit when the abnormality is eliminated.

10. The particulate-measuring system according to claim 6, wherein the control unit determines the abnormality when the measurement unit detects a particular number or more of the particulates continuously for a particular period of time.

11. A system for manufacturing ultrapure water comprising the particulate-measuring system according to claim 6 in its ultrapure water-manufacturing process.
